(19) United States
(12) Patent Application Publication
(10) Pub. No.: US 2010/0183040 A1
(43) Pub. Date: Jul. 22, 2010

(54) Laser source device and laser processing device

(75) Inventors: Yuichi Ishizu, Kusatsu-shi (JP); Fumihiko Nakano, Osaka (JP); Mitsuru Nishimura, Ayabe-shi (JP)

Correspondence Address: RABIN & Berdo, PC, 1101 14TH STREET, NW, SUITE 500, WASHINGTON, DC, 20005, US

(73) Assignee: OMRON Corporation, Kyoto (JP)

(21) Appl. No.: 12/656,167

(22) Filed: Jan. 20, 2010

(30) Foreign Application Priority Data
Jan. 21, 2009 (JP) 2009-011122

(51) Int. Cl. H01S 3/10

(52) U.S. Cl. 372/25

(57) ABSTRACT

A laser source device includes an optical amplifier having an optical amplifying medium that is configured to amplify a seed beam when the seed beam and an exciting beam are entered, a seed beam source for emitting a laser beam as the seed beam, and an exciting beam source for emitting an exciting beam. The seed beam source emits a pulse beam as the seed beam during a predetermined principal irradiation period. The seed beam source emits a substantially continuous beam as the seed beam, having a smaller power than a peak power of the pulse beam during a supplemental irradiation period different from the principal irradiation period. The exciting beam source emits the exciting beam such that the power of the exciting beam is smaller during the supplemental irradiation period than the power of the exciting beam during the principal irradiation period.

### BACKGROUND

The invention is related to a laser source device and a laser processing device including the laser source device.

A typical laser process such as laser marking, laser drilling or laser welding requires a laser device capable of emitting a laser beam having a high peak power.

Processing devices having a solid-state laser resonator including Nd-YAG (Yttrium Aluminum Garnet) or Nd—YVO₄ crystal as a laser source are traditionally known. These processing devices generally employ a Q-switch element for emitting a laser beam pulse having a high peak power.

A typical example of the Q-switch is an AOQ-switch using an acousto-optic element. This Q-switch element is made by applying RF signals (high frequency signals) to an AO element represented by a fused quartz to induce Bragg diffraction inside the element. A resonator is configured such that a laser resonance occurs while diffraction is induced; thereby a photo-switch using diffraction is configured.

In a laser processing device using a O-switch solid-state laser, when the peak power of an output pulse at the start of emission becomes too high, a process trace is distinctly marked in the initial phase of processing. As a result, there is a possibility that the quality of processing may deteriorate.

A laser source device is proposed, including a resonator for generating a laser beam and an amplifier for amplifying the laser beam from the resonator in order to emit a laser beam having a high peak power. The amplifier adopts the MOPA (Master Oscillator and Power Amplifier) method, which is capable of emitting a beam having a high peak power by amplifying, for example a weak laser beam as a seed light.

A laser source using a laser diode (LD) as the seed beam, an amplifier including an optical fiber with a core in which a rare-earth element is doped (which, although generally called a “rare-earth doped optical fiber”, may hereinafter be referred to simply as an “optical fiber”) and a laser processing device using the laser source are proposed.

### BRIEF SUMMARY

According to one aspect of an embodiment of the invention, a laser source device is provided. The laser source device includes an optical amplifier having an optical amplifying medium that is configured to amplify a seed beam when the seed beam and an exciting beam are entered, a seed beam source for emitting a laser beam as the seed beam, and an exciting beam source for emitting an exciting beam. The seed beam source emits a pulse beam as the seed beam during a predetermined principal irradiation period. The seed beam source also emits a substantially continuous beam as the seed beam having a smaller power than a peak power of the pulse beam during a supplemental irradiation period different from the principal irradiation period. The exciting beam source emits the exciting beam such that the power of the exciting beam is smaller during the supplemental irradiation period than the power of the exciting beam during the principal irradiation period.

According to another aspect of the embodiment of the invention, a laser processing device is provided. The laser processing device includes the above-mentioned laser source device, and an optical system for irradiating an object with a beam emitted from the laser source device.

### BRIEF DESCRIPTION OF THE DRAWINGS

FIG. 1 is a view showing a structure of a laser source device and a laser processing device equipped with the laser source device according to the embodiment.

FIG. 2 shows sectional views illustrating structural examples of a double-clad fiber and a single-clad fiber applicable to optical fibers 1, 8, and 221.

FIG. 3 is a time chart illustrating a frame format of controlling the seed beam and the exciting beam according to the embodiment.

FIG. 4 is a view showing an example of a substantially continuous beam.

FIG. 5 is a view showing an ideal state of a pulse beam emitted from the laser source device during laser processing.

FIG. 6 is a time chart illustrating a frame format of an amplified beam power by controlling only emission of the seed beam while keeping constant the exciting beam power.

FIG. 7 is a frame format illustrating processing results by the amplified beam shown in FIG. 6.

FIG. 8 is a view showing a relation between the repeating frequencies of the seed beam and the peak power of the amplified beam emitted from the fiber amplifier just after the start of emission while the seed beam and the exciting beam are controlled as shown in FIG. 6.

FIG. 9 is a view showing a change of the amplified beam power in accordance with a change of the seed beam power during the supplemental irradiation period.

FIG. 10 is a view showing a change of the amplified beam power in accordance with a change of the exciting beam power during the supplemental irradiation period.

FIG. 11 is a view showing a change of the amplified beam power in accordance with a change of timing of boosting the exciting beam power.

FIG. 12 is a first view showing an effect the peak energy of the pulse beam has on processing results when irradiating a resin with the pulse beam.

FIG. 13 is a second view showing an effect the peak energy of the pulse beam has on processing results when irradiating a resin with the pulse beam.

FIG. 14 is a third view showing an effect the peak energy of the pulse beam has on processing results when irradiating a resin with the pulse beam.

FIG. 15 is a first view showing an effect the peak energy of the pulse beam has on processing results when irradiating a metal with the pulse beam.

FIG. 16 is a second view showing an effect the peak energy of the pulse beam has on processing results when irradiating a metal with the pulse beam.

FIG. 17 is a view showing a configuration of a first modification of a laser source device according to the embodiment.

FIG. 17 is a view showing a configuration of a first modification of a laser source device according to the embodiment.

FIG. 18 is a view showing a configuration of a second modification of a laser source device according to the embodiment.

FIG. 19 is a view showing a configuration of a third modification of a laser source device according to the embodiment.

FIG. 20 is a view showing a configuration of a fourth modification of a laser source device according to the embodiment.

### DETAILED DESCRIPTION

Hereinafter, the embodiments of the invention are described in detail with reference to the drawings. The same symbols are applied to the same and the corresponding parts in the drawings and are not repeatedly described.

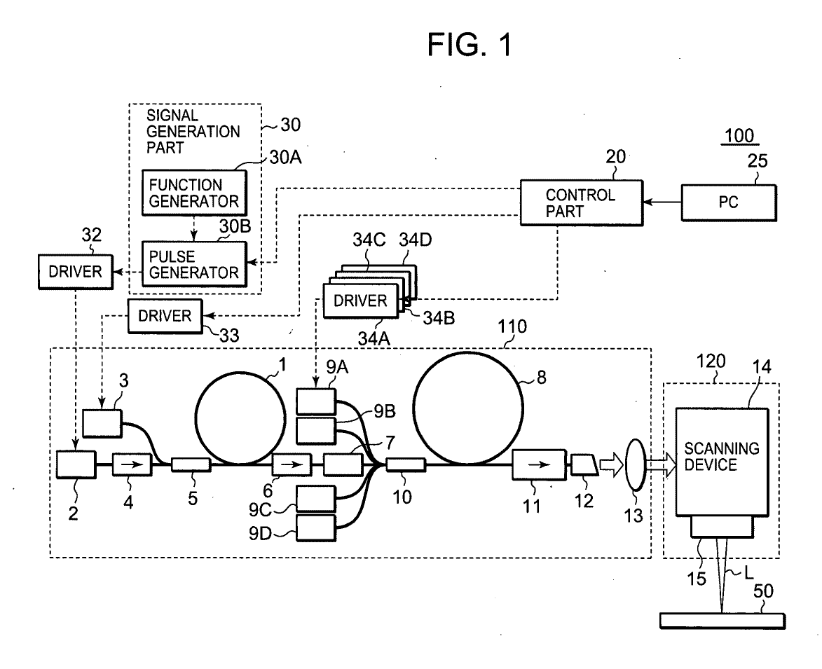

FIG. 1 is a view showing a structure of a laser source device and a laser processing device equipped with the laser source device according to the embodiment. The laser processing device 100 has a laser source device 110 and a laser emission device 120 with reference to FIG. 1.

The laser source device 110 has an optical fiber 1, laser diodes 2, 3, isolators 4, 6, and a coupler 5.

The optical fiber 1 has a core doped by a rare-earth element, being an optical amplifying content. The types of the rare-earth element are for example Er (erbium), Yb (ytterbium), are Nd (neodymium), but not limited to these elements. The rare-earth element doped in the core is Yb (ytterbium) according to the embodiment.

Generally, an optical fiber has a clad around the core, which has a little bit lower refraction index than the core (for example, approximately 1% lower). In this embodiment, a double-clad fiber which has a double clad around the core is adopted for the fiber 1. However, a single-clad fiber which has a single clad around the core is available for the fiber 1 as well.

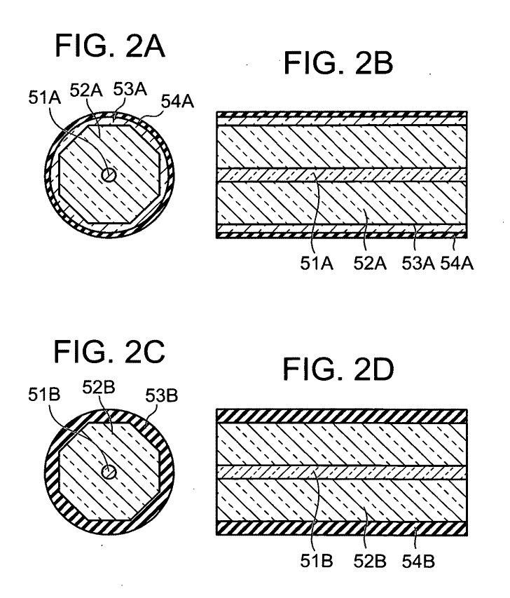

FIG. 2 shows sectional views illustrating structural examples of a double-clad fiber and a single-clad fiber applicable to optical fibers 1, 8, and 221. The optical fibers 1, 8 and 221 are detailed later.

FIGS. 2(A) and 2(B) show vertical and horizontal sectional views of the double-clad fiber in its extending direction respectively.

FIGS. 2(C) and 2(D) show vertical and horizontal sectional views of the single-clad fiber in its extending direction respectively.

With reference to FIGS. 2(A) and 2(B), the double-clad fiber includes a rare-earth doped core 51A, a clad 52A (first clad) which is provided around the core 51A and has a lower refraction index than the core 51A, a clad 53A (second clad) which is provided around the clad 52A and has a lower refraction index than the clad 52A, and a coating 54A.

With reference to FIGS. 2(C) and 2(D), the single-clad fiber includes a rare-earth doped core 51B, a clad 52B which is provided around the core 51B and has a lower refraction index than the core 51B, and a coating 54B which is provided around the clad 52B.

Going back to FIG. 1, the laser diode 2 is a seed beam source emitting the seed beam. The wavelength of the seed beam is for example 1062±2 nm. The laser diode 2 emits a pulse beam or a substantially continuous beam (hereinafter may be simply referred to as continuous beam) as the seed beam as detailed later. In other words, the laser diode 2 switches pulse oscillation and continuous oscillation.

The isolator passes a beam with one way and blocks the beam with opposite direction to the way. The isolator 4 passes the seed beam emitted from the laser diode 2 while it blocks a returning beam from the optical fiber 1. In this way, damage to the laser diode 2 can be avoided, since the returning beam to the laser diode 2 can be blocked.

The laser diode 3 is an exciting beam source for emitting an exciting beam to excite the rare-earth doped in the core of the optical fiber 1. The wavelength of the exciting beam is determined by the type of the rare-earth doped in the core of an optical fiber. For example, if the rare-earth element is Yb, the wavelength of the exciting beam is for example 940±10 nm.

The coupler 5 couples the seed beam from the laser diode 2 and the exciting beam from the laser diode 3 and enters them into the optical fiber 1. For example, a WDM (Wavelength Division Multiplexing) coupler or a combiner can be used as the coupler 5.

Since the optical fiber 1 according to this embodiment is a double-clad fiber, the seed beam from the laser diode 2 enters into the core, while the exciting beam from the laser diode 3 enters into the first clad of the double-clad fiber. The exciting beam from the laser diode 3 is propagated through the first clad while it is repeatedly reflected at the interface between the first clad and the second clad. A part of the exciting beam passing through the first clad is absorbed by the rare-earth element while it passes through the core. The rare-earth element is excited (shifted from ground level to upper level) by this absorption, population-inversion state occurs. When the seed beam from the laser diode 2 enters into the core of the optical fiber 1 in this state, an induced emission takes place. The seed beam (pulse beam) is amplified by this induced emission.

In the case of the double-clad optical fiber, the amount of the exciting beam absorbed by the rare-earth element can be increased by confining the exciting beam in the first clad. Thus, the power of the pulse beam emitted from the optical fiber 1 can be enhanced.

In the case of the single-clad optical fiber, both the seed and exciting beams are entered into the core of the fiber 1.

The isolator 6 passes the pulse beam emitted from the optical fiber 1, while it blocks the pulse beam returning to the optical fiber 1.

The laser source device 110 further includes a bandpass filter 7, an optical fiber 8, laser diodes 9A to 9D, a coupler 10, an isolator 11, an end cap 12 and a collimator lens 13.

The bandpass filter 7 is configured to pass a predetermined range of wavelength. The predetermined range of wavelength is a specific range that includes a peak wavelength of the pulse beam emitted from the optical fiber 1. If a naturally-emitted light is emitted from the optical fiber 1, such light is eliminated by the bandpass filter 7.

The optical fiber 8 includes a rare-earth doped core. The optical fiber 8 is the same double-clad fiber as the optical fiber 1. Since the structure of the optical fiber 8 is the same as the one shown in FIG. 2, the description is not repeated. The single-clad fiber having a rare-earth doped core can be used for the optical fiber 8 as well.

The laser diodes 9A to 9D are exciting beam sources for emitting an exciting beam to excite the rare-earth element included in the core of the optical fiber 8. Although four exciting beam sources are provided for the optical fiber 8 according to the embodiment, the number of laser diodes used as exciting beam sources is not limited to four.

The coupler 10 couples the pulse beam passing through the bandpass filter 7 and the beams from the laser diodes 9A to 9D and enters them into the optical fiber 8. The pulse beam passing through the bandpass filter 7 is propagated through the core of the double-clad fiber (optical fiber 8). The beams from the laser diodes 9A to 9D are entered into the first clad of the optical fiber 8. The rare-earth element included in the core of the optical fiber 8 is excited by the beams from the laser diodes 9A to 9D in the same manner as the optical fiber 1. When the pulse beam passing through the bandpass filter 7 enters into the core of the optical fiber 8, the pulse beam is amplified by the induced emission of the rare-earth element.

A pulse beam having a peak power sufficiently strong to process the object 50 is obtained by optical amplifying operation in the fibers 1 and 8. If the bandpass filter 7 is not provided, the naturally-emitted light emitted from the optical fiber 1 may be entered into the optical fiber 8. The naturally-emitted light, if amplified by the optical fiber 8, may lower an amplification factor of the pulse beam used for processing. The pulse beam can be amplified at a high efficiency, by eliminating the naturally emitted light by the bandpass filter 7.

The isolator 11 passes the pulse beam emitted from the optical fiber 8 and blocks the beam returning to the optical fiber 8. The pulse beam passing through the isolator 11 is emitted into the atmosphere from the end face following the isolator 11. The end cap 12 is provided to prevent the damage caused between the end face of an optical fiber and the atmosphere when the pulse beam having a high peak power is emitted into the atmosphere.

The collimator lens 13 adjusts a spatial size (beam diameter) of the pulse beam emitted into the atmosphere into a predetermined size. The pulse beam passing through the collimator enters into the laser emission device 120.

As mentioned above, the laser source device 110 includes the laser diode 2 as the seed beam source, the laser diode 3 as the exciting beam source, and the optical amplifier having the optical amplifying medium (optical fibers 1 and 8) that can amplify the seed beam when the seed beam and the exciting beam are entered. The optical amplifier is a fiber amplifier including rare-earth doped fibers (fibers 1 and 8) according to the structure shown in FIG. 1. Further, the fiber amplifier is configured to have two phases according to the structure shown in FIG. 1. However, the number of the fiber amplifier may be one or more than two and is not limited to two.

The laser emission device 120 has a scanning device 14 and a collective lens 15. The scanning device 14 scans the entering beam at least in a single-dimension direction. The scanning device 14 can scan the entering beam in a two-dimension direction according to this embodiment. For example, a galvanometer, a polygon mirror, a MEMS (Micro-Electro-Mechanical-Systems) scanner can be used for the scanning device.

The collective lens 15 collects the pulse beams from the scanning device 14. The collected pulse beam (laser beam L) irradiates the surface of an object 50. Thus, the object is processed.

The laser processing device 100 is used as a laser marking device according to this embodiment. The surface of the object 50 is marked information including letters and graphics by the pulse beam.

The laser processing device 100 further includes a control part 20, a PC 25, a signal generation part 30, and drivers 32, 33 and 34A to 34D. The signal generation part 30 includes a function generator 30A and a pulse generator 30B.

The control part 20 controls the laser diodes 2, 3, 9A to 9D by controlling the signal generation part 30 and drivers 32, 33 and 34A to 34D. The scanning device 14 may be controlled by the control part 20 or by a control device different from the control part 20.

The PC 25 is received information relating to a control of laser processing from a user and sends the control information to the control part 20. Such control information includes a scanning rate and repeating frequency of the pulse beam, and a material (metal, resin, etc.) of the object, etc.

The function generator 30A generates a signal voltage having a desired waveform and/or a desired frequency. The pulse generator 30B generates a control voltage to control the driver 32 in accordance with signal voltages generated by the control part 20 and the function generator 30A, thereby sending an instruction to driver 32 in order to drive the laser diode 2.

A signal having a predetermined repeating frequency and a predetermined duty ratio is sent from the pulse generator 30B to the driver 32 in order to generate a pulse oscillation by the laser diode 2. The driver 32 supplies a drive current to the laser diode 2 in accordance with the signal. Thus, the laser diode 2 oscillates and emits the pulse beam as the seed beam. The repeating frequency of the pulse beam is determined to have some appropriate value, for example within a range from 10 kHz to 1 MHz, while the pulse width is determined to have some appropriate value, for example within a range from 5 to 100 ns.

In order to generate a continuous oscillation by the laser diode 2, the pulse generator 30B sends to the driver 32 a signal having a substantially constant intensity. The driver 32 supplies a drive current corresponding to the signal to the laser diode 2. The laser diode 2 thereby oscillates continuously to emit a continuous beam as the seed beam.

Further, the driver 32 changes the intensity of the drive current when the laser diode 2 oscillates continuously or pulse oscillates. For example, it is possible to change the drive current by the pulse generator 30B changing the intensity of the signal while the laser diode 2 oscillates continuously or pulse oscillates and by the driver 32 amplifying the signal.

The drivers 33 and 34A to 34D supply the drive current to the respective laser diodes 3 and 9A to 9D corresponding to the instruction from the control part 20. The respective drivers 33 and 34A to 34D apply the drive current to the corresponding laser diodes to make them oscillate continuously. The laser diodes 3 and 9A to 9D thereby emit the continuous beams as the exciting beam.

Further, the drivers 33 and 34A to 34D change the intensity of the drive current corresponding to the instruction from the control part 20. The powers of the exciting beams the laser diodes 3 and 9A to 9D emit thereby change.

In this way, the control part 20, the signal generation part 30 and the driver 32 control the start and the stop of the seed beam emission by the laser diode 2, while they control the type of the seed beam (either a pulse beam or a substantially continuous beam), the repeating frequency of the pulse beam, the duty ratio of the pulse beam, the peak power of the pulse beam and the power of the continuous beam. Similarly, the control part 20 and the driver 33 control the start and the stop of the exciting beam emission by the laser diode 3, while they control the power of the exciting beam. Similarly, the control part 20 and the drivers 34A to 34D control the start and the stop of the exciting beam emission by the laser diode 9A to 9D, while they control the power of the exciting beam.

Temperature controllers may be provided for the respective laser diodes to control the temperatures thereof, though they are not shown in FIG. 1. They are intended to make stable the output of the laser diodes by making stable the temperatures of them. Further, the temperature controllers may be provided for the bandpass filter 7 and/or the isolator 6 as well.

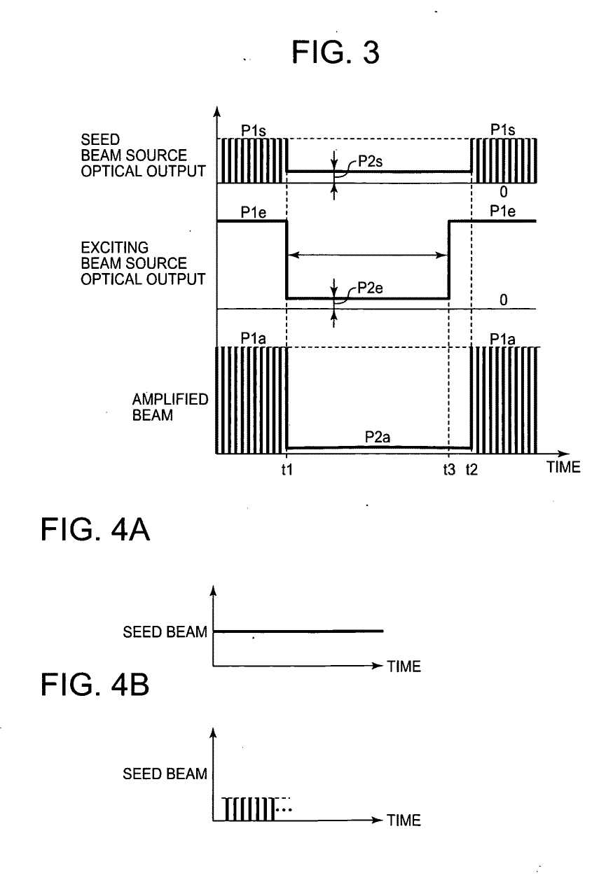

FIG. 3 is a time chart illustrating a frame format of controlling the seed beam and the exciting beam according to the embodiment.

With reference to FIGS. 1 and 3, a laser processing of the object 50 is performed during a period before t1 and after t2. A pulse beam is outputted as the seed beam from the seed beam source, while a continuous beam is outputted as the exciting beam from the exciting beam source during the above-mentioned period. Thus, the optical fibers 1 and 8 amplify the seed beam.

In FIG. 3, the peak power of the seed beam, the power of the exciting beam, and the peak power of the beam amplified by the optical fibers 1 and 8 (amplified beam) are represented by P1s, P1e and P1a respectively. The “seed beam source” corresponds to the laser diode 2 shown in FIG. 1, while the “exciting beam source” collectively represents the laser diodes 3 and 9A to 9D shown in FIG. 1. However, the “exciting source” shown in FIG. 3 may represent the laser diode 3 and the “amplified beam” may represent the beam emitted from the fiber 1 in the following description.

The laser processing is not performed for the object 50 during a period from time t1 to t2. During this period, the seed beam source emits a substantially continuous beam as the seed beam with its peak power shifted from P1s to P2s.

On the other hand, the exciting beam source lowers the power of the continuous beam from P1e to P2e synchronized with the change of the seed beam from the pulse beam to the continuous beam. Specifically, the exciting beam source lowers the power of the exciting beam at the time t1.

However, the exciting beam source boosts the power of the exciting beam from P2e to P1e earlier than the seed beam source changes its seed beam from the substantially continuous beam to the pulse beam. As shown in FIG. 3, the power of the exciting beam is boosted from P2e to P1e at the time t3. Accordingly, the power of the exciting beam stays in P2e during the period from the time t1 to the time t3. The laser diodes 3 and 9A to 9D are synchronized to each other in order to boost and lower the power of the exciting beam.

The power of the amplified beam stays in P2a from the time t1 to the time t2 and stays in P1a before and after the time t1 and the time t2 respectively.

Hereinafter, the period when the seed beam source emits a pulse beam is called a “principal irradiation period” and the period when the seed beam source emits a substantially continuous beam is called a “supplemental irradiation period.” During the principal irradiation period, the optical fiber 8 emits an amplified beam having a power P1a that enables a laser processing. The principal irradiation period is preliminarily determined by the irradiation conditions of the laser source device 110. The supplemental irradiation period is a period before a principal irradiation period.

Next, the “substantially continuous beam” emitted from the seed beam source during the supplemental irradiation period is described in detail.

FIG. 4 is a view showing an example of a substantially continuous beam. FIG. 4A shows an example of a waveform of the seed beam during the supplemental irradiation period. With reference to FIG. 4A, the seed beam is a beam where its power changes continuously with respect to a time-axis.

FIG. 4B shows another example of a waveform of the seed beam during the supplemental irradiation period. In this example, the seed beam is a pulse beam. However, the repeating frequency of the pulse beam is extremely high in contrast with that of the seed beam during the principal irradiation period. Thus, the time interval of the pulse beam during the supplemental irradiation period becomes extremely small in contrast with that of the pulse beam during the principal irradiation period. Thus, the seed beam during the supplemental irradiation period becomes a beam that can be deemed as a continuous beam.

A substantially continuous beam may be emitted from the seed beam source by increasing a duty ratio of the pulse beam (a ratio of emission period to a cycle of pulse beam emission) though it is not shown in the drawings. Since the non-emission period of the pulse beam can be shortened by increasing the duty ratio, a substantially continuous beam can be obtained.

Thus the “substantially continuous beam” includes a beam where its power changes continuously (being constant or changing continuously) with respect to a time-axis. Further, the “substantially continuous beam” includes a pulse beam which has an extremely short noncontinuous period in contrast with that of the pulse beam when it is emitted as the seed beam.

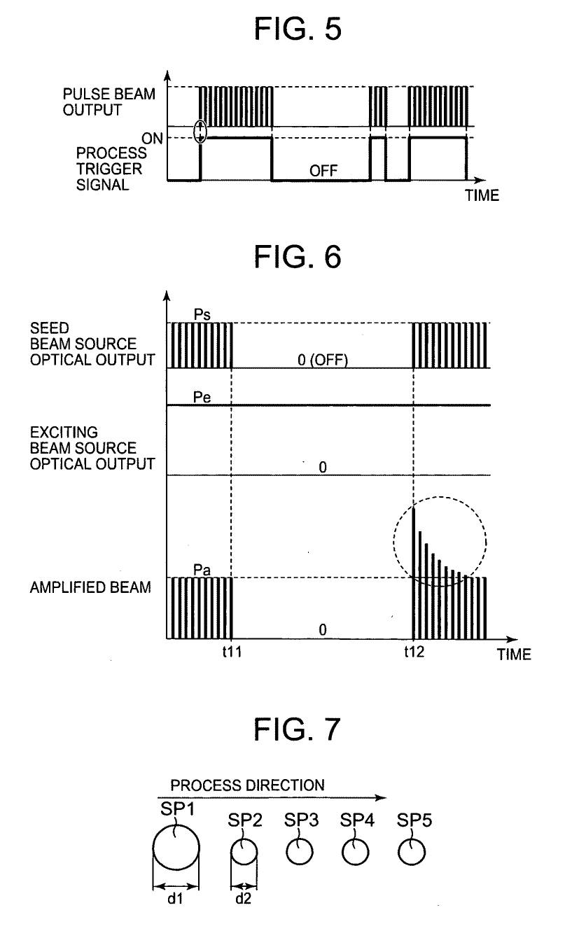

FIG. 5 is a view showing an ideal state of a pulse beam emitted from the laser source device during laser processing.

With reference to FIG. 5, a process-trigger signal (for example provided from the control part) is set ON at the start of laser processing. The laser source device emits a pulse beam, i.e. an amplified beam accordingly. In an ideal condition, a pulse beam is emitted following the process-trigger signal without delay and the peak power of the pulse beam becomes stable from the start of processing. Further, the peak power of the pulse beam becomes stable from the start of processing irrespective of the length of off-period of the process-trigger signal.

Accordingly, since the pulse beam (laser beam) having a stable power irrespective of the length of processing or non-processing period can be outputted from the start of processing without delay, a high quality processing can be performed.

The exciting beam is entered into the beam-amplifying medium (optical fiber) to excite it according to the embodiment. In other words, energy is accumulated in the beam-amplifying medium. The excited beam-amplifying medium, when the seed beam is inputted, releases a part of the accumulated energy as a beam, thereby amplifying the seed beam.

In order to emit a laser beam that turns on and off as shown in FIG. 5, the seed beam source must start and stop an emission of the seed beam. However, starting and stopping emission of the seed beam may cause the following problems.

FIG. 6 is a time chart illustrating a frame format of an amplified beam power by controlling only emission of the seed beam while keeping constant the exciting beam power.

With reference to FIG. 6, a laser processing is performed for the object 50 during the period before the time t11 and after the time t12. During the period, the pulse beam having a peak power Ps is outputted from the seed beam source, while the exciting beam having a power Pe is outputted from the exciting beam source. An optical amplifier including an optical amplifying medium (rare-earth doped fiber) emits an amplified beam (pulse beam) having a peak power Pa by amplifying the seed beam.

The seed beam source is stopped to emit the seed beam during the period from the time t11 to t12, while emission of the exciting beam from the exciting beam source is continued. During this period energy is accumulated in the optical amplifying medium. When a seed beam is inputted into the optical amplifying medium during the above-mentioned condition, energy released from the optical amplifying medium is increased. Accordingly, an extremely increased peak power (hereinafter referred to as a giant pulse (GP)) is outputted from the optical amplifier just after emission of the amplified beam is started (at t12).

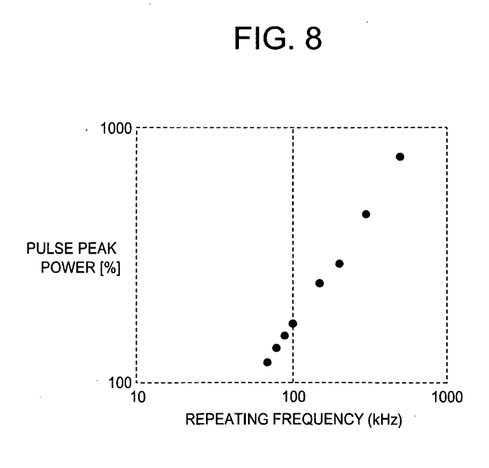

FIG. 7 is a frame format illustrating processing results by the amplified beam shown in FIG. 6. With reference to FIG. 7, spots SP1 to SP5 represent spots that are formed when an amplified beam having high peak energy irradiates the surface of the object. The direction from the spot SP1 to the spot SP5 represents a direction of processing, i.e. a scanning direction of the amplified beam.

The spot SP1 shows a processing trace that is formed on the surface of the object by a pulse beam just after emission from the optical amplifier is started. The peak energy just after a start of emission is significantly high in contrast with the peak energy of a pulse beam in a regular state (corresponding to Pa shown in FIG. 6) as shown in FIG. 6. Thus the diameter d1 of the spot SP1 becomes significantly larger than other spots (for example the diameter d2 of the spot SP2). There is a possibility that a problem relating to a processing quality such as a low processing accuracy may occur when the surface of the object is processed as described above.

FIG. 8 is a view showing a relation between the repeating frequencies of the seed beam and the peak power of the amplified beam emitted from the fiber amplifier just after the start of emission while the seed beam and the exciting beam are controlled as shown in FIG. 6.

With reference to FIG. 8, a reference of the peak power (100%) is set to the peak power of the pulse beam just after beam emission is started with a repeating frequency set to 70 kHz. In addition, a non-emission period (corresponding to a period from the time t11 to the time t12 in FIG. 6) of the seed beam is set to approximately 50 μs. These references are set for convenience and are not limited as above. The higher the repeating frequency becomes, the higher the peak power of the pulse beam becomes just after emission from the fiber amplifier.

With reference to FIG. 3 again, the seed beam becomes a substantially continuous beam during a supplemental irradiation period according to the embodiment. Further, the power of an exciting beam during the supplemental irradiation period is lower than a peak power of a seed beam during the principal irradiation period. A power of the exciting beam during the supplemental irradiation period is lower than a peak power of the exciting beam during the principal irradiation period.

The accumulation of energy in optical fibers 1 and 8 is controlled by making the peak power of the exciting beam lower during the supplemental irradiation period than during the principal irradiation period. A substantially continuous beam is inputted into the optical fibers 1 and 8 as the seed beam during the supplemental irradiation period in the embodiment. The optical fibers 1 and 8 output an amplified beam corresponding to an input of the seed beam. A part of the accumulated energy is thereby released from the optical fibers 1 and 8. Thus, the optical fibers 1 and 8 are prevented from continuing to accumulate energy.

Accumulation of energy in the optical fibers 1 and 8 is thus controlled during the supplemental irradiation period. Therefore, the optical fiber amplifier is prevented from generating a giant pulse at the start of emission during the principal irradiation period.

Further the substantially continuous beam is inputted to the fibers 1 and 8 during the supplemental irradiation period. Thus, the fiber amplifier is prevented from outputting a pulse beam having a comparatively high peak power during the supplemental irradiation period. An amplified beam is outputted from the fiber amplifier during the supplemental irradiation period as well according to the embodiment. The surface of the object may be processed if peak energy of an amplified beam outputted from the fiber amplifier is high during the supplemental irradiation period. The power of a beam outputted from the fiber amplifier during the supplemental irradiation period may be controlled by making the seed beam to be a substantially continuous beam during the supplemental irradiation period. Therefore, an unwanted processing on the surface of the object may be prevented.

Further the power of the exciting beam is boosted before the seed beam is changed from the substantially continuous beam to the pulse beam. If the energy accumulated in the optical fibers 1 and 8 is too low, the peak power of a pulse beam outputted at the start of emission may not be sufficiently high (for example not sufficiently high for processing). Since the optical fibers 1 and 8 can appropriately accumulate the energy by preliminarily boosting the power of the exciting beam, a pulse beam having a desired power (for example sufficiently high power for processing) can be obtained.

### <Irradiation Condition>

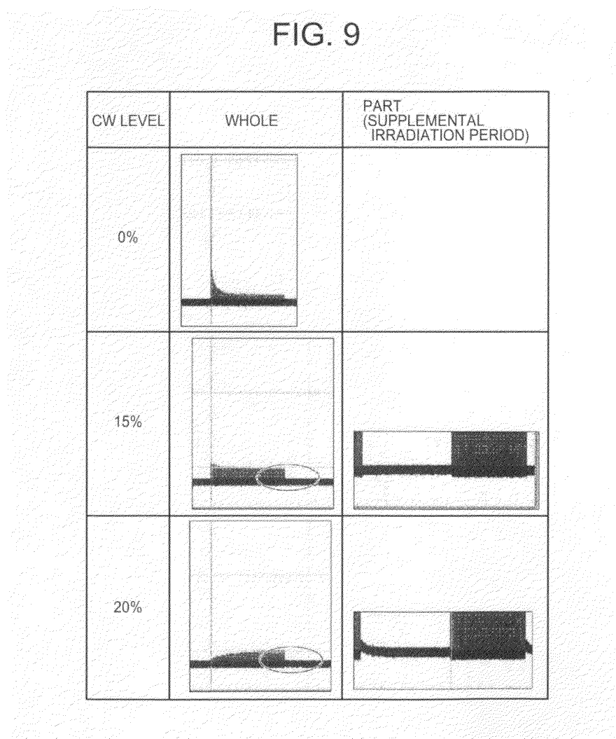

FIG. 9 is a view showing a change of the amplified beam power in accordance with a change of the seed beam power during the supplemental irradiation period. The power of the exciting beam is set to the same level for both during the principal irradiation period and the supplemental irradiation period.

In FIG. 9, CW level means a ratio of a power of the seed beam during the supplemental irradiation period to a power of the seed beam during the principal irradiation period. When CW level is zero, no seed beam is outputted. This shows the state where the seed beam and the exciting beam are controlled as shown in FIG. 6.

With reference to the waveform of an amplified beam (“whole”), the peak energy of an amplified beam just after the start of emission is significantly high in comparison with the peak energy afterward when CW level is zero. On the other hand, the peak energy of an amplified beam can be made stable from just after the start of emission when the CW level is between 15% to 20%.

With reference to the enlarged waveform of an amplified beam (“part” (supplemental irradiation period)), the power of the amplified beam is increased as the CW level goes up.

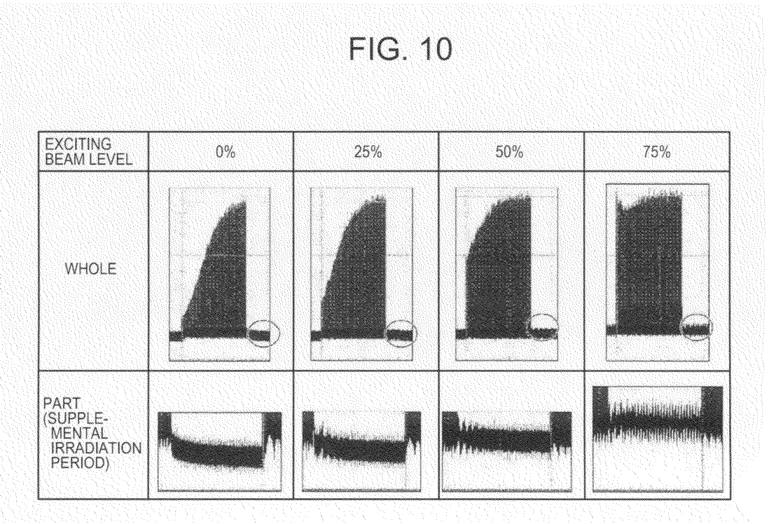

FIG. 10 is a view showing a change of the amplified beam power in accordance with a change of the exciting beam power during the supplemental irradiation period. The power of the seed beam during the supplemental irradiation period is set to 15% of the power of the seed beam during the principal irradiation period. In other words, CW level is 15%.

With reference to FIG. 10, the “exciting beam level” means a ratio of the power of an exciting beam during the supplemental irradiation period to the power of an exciting beam during the principal irradiation period. As the exciting beam level is increased, the power of an amplified beam is increased just after the start of emission during the principal irradiation period. However, as the exciting beam level is increased, the power of an amplified beam is also increased during the supplemental irradiation period.

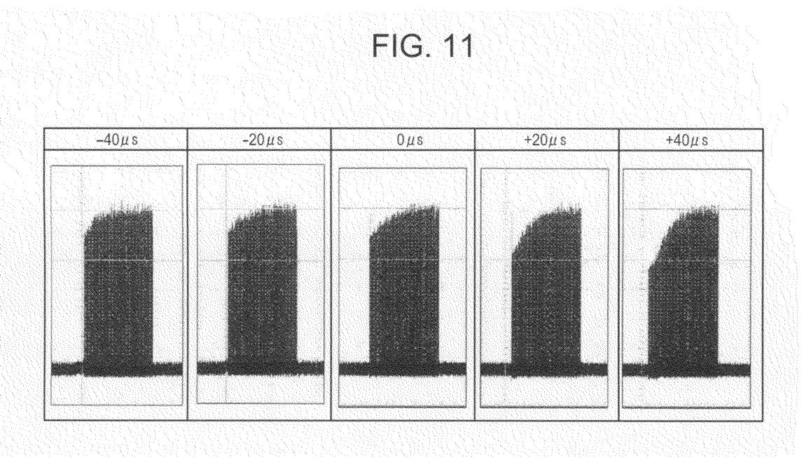

FIG. 11 is a view showing a change of the amplified beam power in accordance with a change of timing of boosting the exciting beam power. A CW level is set to 15% and an exciting beam level is set to 75%.

With reference to FIG. 11, a delay from the reference time when the seed beam is changed from the substantially continuous beam to the pulse beam to the time when the power of the exciting beam is boosted, is set to −40 μs, −20 μs, 0 μs, +20 μs, and +40 μs. The negative delay time means that the power of the exciting beam is boosted before the seed beam is changed from the substantially continuous beam to the pulse beam. The peak power of an amplified beam can be increased at the start of emission during the principal irradiation period by shifting the delay time in a negative direction. On the other hand, the peak power of an amplified beam can be decreased at the start of emission during the principal irradiation period by shifting the delay time in a positive direction.

In this way, it is possible to control the power of an amplified beam outputted from the optical amplifier at the start of emission during the principal irradiation period by controlling the power of the seed beam and the exiting beam, and changing the timing of boosting the exciting beam.

Thus, high quality processing is realized during laser processing by using a laser beam (amplified beam) outputted from a laser source device.

### <Effect on Processing Results by Peak Energy of Pulse Beam>

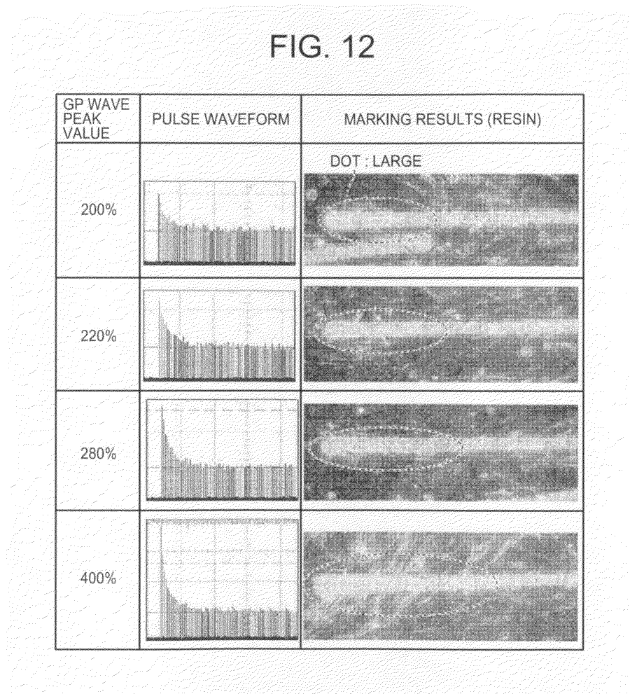

FIG. 12 is a first view showing an effect the peak energy of the pulse beam has on processing results when irradiating a resin with the pulse beam.

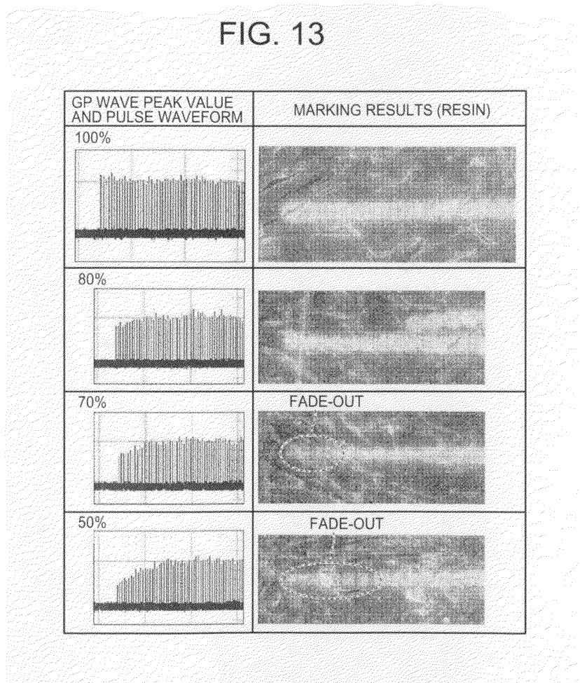

FIG. 13 is a second view showing an effect the peak energy of the pulse beam has on processing results when irradiating a resin with the pulse beam.

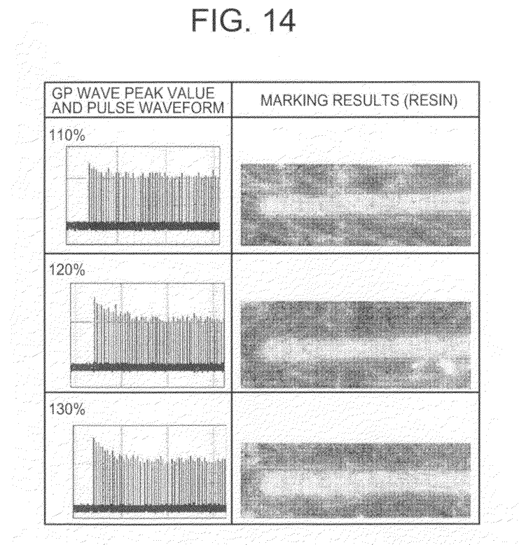

FIG. 14 is a third view showing an effect the peak energy of the pulse beam has on processing results when irradiating a resin with the pulse beam.

With reference to FIGS. 12 to 14, the object is made of resin, specifically PBT (Polybutylene Terephthalate). A “GP wave peak value” represents a ratio of the peak power of an amplified beam at the start of emission during the principal irradiation period to the peak power of an amplified beam (pulse beam) in a steady state.

FIG. 12 shows marking results when the GP wave peak value is 200%, 220%, 280% and 400% respectively. As the wave peak value goes up, a domain with a large dot appears extended.

FIGS. 13 and 14 shows marking results when the GP wave peak value is 100%, 50%, 70%, 80%, 110%, 120%, and 130% respectively. The dots on the surface of the resin looks faded out at 70% and 50%. No such fade-out states occur at 80%, 110%, 120% and 130%.

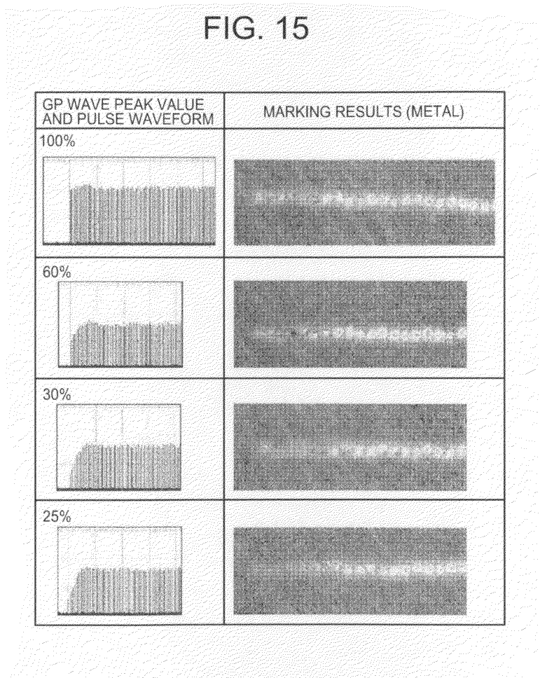

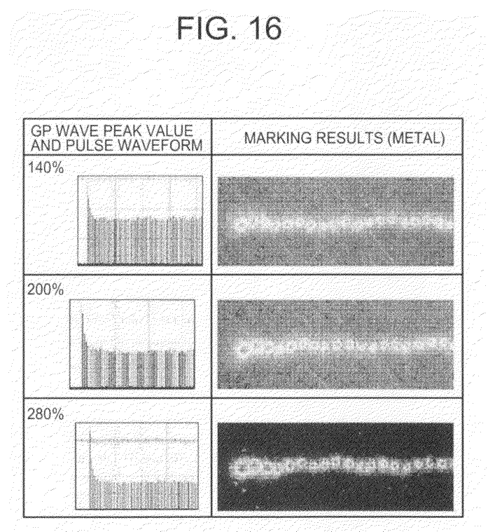

FIG. 15 is a first view showing an effect the peak energy of the pulse beam has on processing results when irradiating a metal with the pulse beam. FIG. 16 is a second view showing an effect the peak energy of the pulse beam has on processing results when irradiating a metal with the pulse beam.

With reference to FIGS. 15 and 16, the object is made of metal, specifically aluminum. FIG. 15 shows marking results when the GP wave peak value is 100%, 60%, 30%, and 25% respectively. As the GP wave peak value is lowered, marking becomes unclear. FIG. 16 shows marking results when the GP wave peak value is 140%, 200% and 280% respectively. When the peak power is significantly high (for example, at 200% and 280%), the processing trace becomes extensive. In this case, the effect on the processing quality becomes significant.

Although the peak energy of the amplified beam is preferably stable from the start of the principal irradiation period, this is not necessarily indispensable. The peak energy of the amplified beam can be controlled, for example such that it gradually attenuates to become stable eventually, even if it is fairy high at first. However, the giant pulse is preferably controlled not to appear. The peak energy of the amplified beam can also be controlled to rise with time.

<Another Configuration of Laser Source Device according to the Embodiment>

Any of the laser source devices described below can be used for the beam source of a laser processing device. The following examples are a part of the configuration of the laser source device according to the embodiment. The configuration of the invention is not limited to the configuration shown in FIG. 1 and the following descriptions.

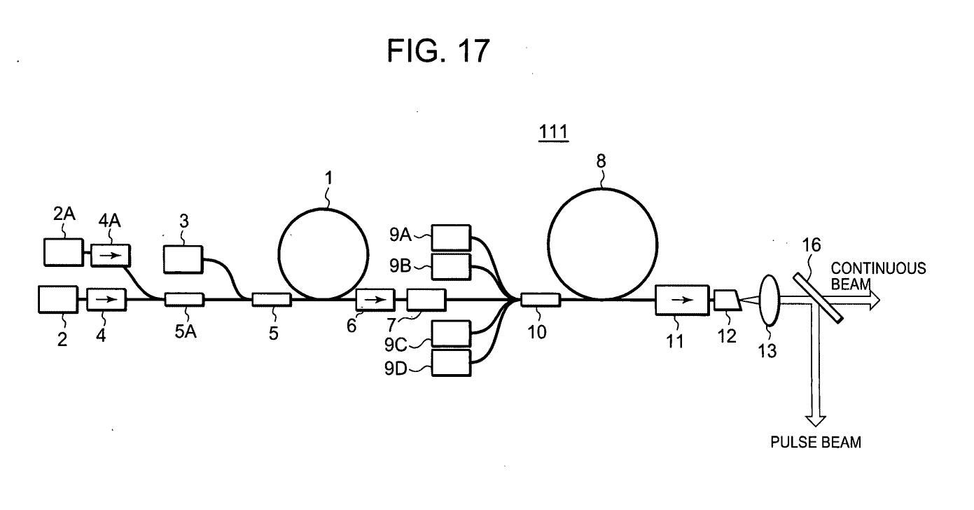

FIG. 17 is a view showing a configuration of a first modification of a laser source device according to the embodiment. With reference to FIG. 17, a laser source device 111 includes a laser diode 2 for generating a pulse beam as the seed beam source and a laser diode 2A for generating a substantially continuous beam. The wavelength of the pulse beam outputted from the laser diode 2 and the wavelength of the continuous beam are different from each other.

With reference to FIGS. 17 and 1, the structural difference between the laser source device 111 and the laser source device 110 is described. The laser source device 111 is different from the laser source device 110 shown in FIG. 1 in that it further includes a laser diode 2A, an isolator 4A, a coupler 5A and a dichroic mirror 16.

During the principal irradiation period, the laser diode 2 outputs a pulse beam, while the laser diode 2A stops outputting a continuous beam. During the supplemental irradiation period, the laser diode 2A outputs the continuous beam, while the laser diode 2 stops outputting the pulse beam. The continuous beam outputted from the laser diode 2A is entered into the optical fiber 1 through the isolator 4A, and the couplers 5A and 5.

Switching between the pulse beam and the continuous beam is realized by controlling drivers corresponding to the laser diodes 2 and 2A. The beam outputted from the laser diode 2A has for example a waveform shown in FIG. 4.

The dichroic mirror 16 reflects a beam with a predetermined wavelength, while it passes beams with other wavelengths. In this modification, the predetermined wavelength is set to the wavelength of the pulse beam outputted from the optical fiber 8. In other words, the pulse beam outputted from the laser diode 2 and amplified by the optical fibers 1 and 8 is reflected by the dichroic mirror 16. This pulse beam is introduced to a scanning device (corresponding to the scanning device 14 in FIG. 1) and used for processing the object.

On the other hand, the continuous beam outputted from the laser diode 2A and amplified by optical fibers 1 and 5 does not irradiate the surface of the object because it passes through the dichroic mirror 16. Thus, it can be avoided according to this modification to process the object by using the beam outputted from the optical fiber during the supplemental irradiation period.

Any element that can separate a pulse beam and a continuous beam based on the wavelength is applicable to this modification in addition to the dichroic mirror 16.

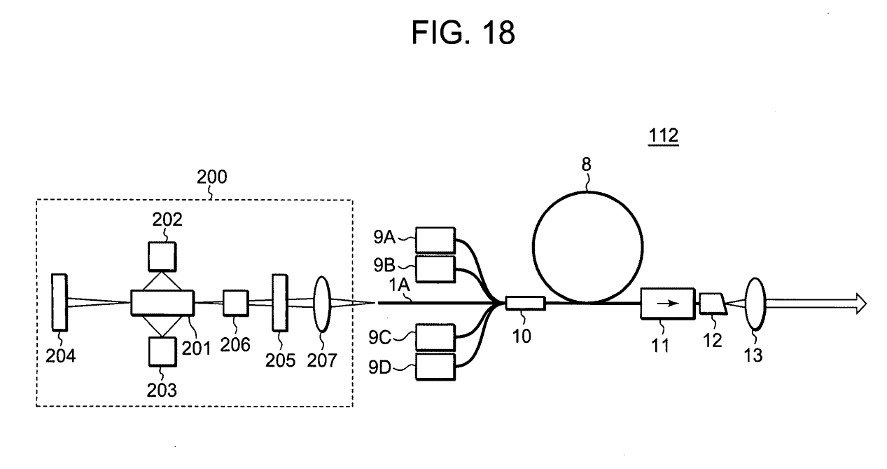

FIG. 18 is a view showing a configuration of a second modification of a laser source device according to the embodiment. With reference to FIG. 18, the laser source device 112 includes a laser diode resonator 200 as the seed beam source. With reference to FIGS. 18 and 1, the structural difference between the laser source device 112 and the laser source device 110 is described. The laser source device 112 is different from the laser source device 110 shown in FIG. 1 in that it has a laser diode resonator 200 and an optical fiber 1A in place of the laser diodes 2 and 3, the isolator 4 and the coupler 5.

The laser diode resonator 200 includes a laser medium 201, exciting beam sources 202 and 203, a reflection mirror 204, an emitting mirror 205, Q-switch 206 and a collective lens 207.

The laser medium 201 is a solid medium, for example an Nd-YAG crystal. An exciting beam is emitted on the laser medium 201 to excite the laser medium 201 and the exciting beam sources 202 and 203. The Q-switch 206 is cyclically set on and off by the control part 20 (see FIG. 1). Thus, the laser diode resonator 200 repeatedly emits the pulse beam as the seed beam. The Q-switch is an emission control part configured to enable cyclically emitting the seed beam from the seed beam source.

The seed beam (pulse beam) emitting from the emitting mirror 205 is collected by the collective lens 207 and enters into the optical fiber 1A. The seed beam is coupled with the exciting beams emitted from the laser diodes 9A to 9D by the coupler 10 and enters into the optical fiber 8. Thus, the seed beam from the laser diode resonator 200 is amplified and emitted from the optical fiber 8. In this configuration, the optical fiber 8 is an optical amplifying medium included in the fiber amplifier.

The pulse beam as the seed beam can be generated by turning the Q-switch on and off. It is possible to emit the substantially continuous beam as the seed beam from the laser diode resonator 200 by turning the O-switch on and off (for example, by increasing an operation frequency or changing a duty ratio of O-switch 206) such that the non-emission period of the seed beam is shorter than the emission period of the pulse beam.

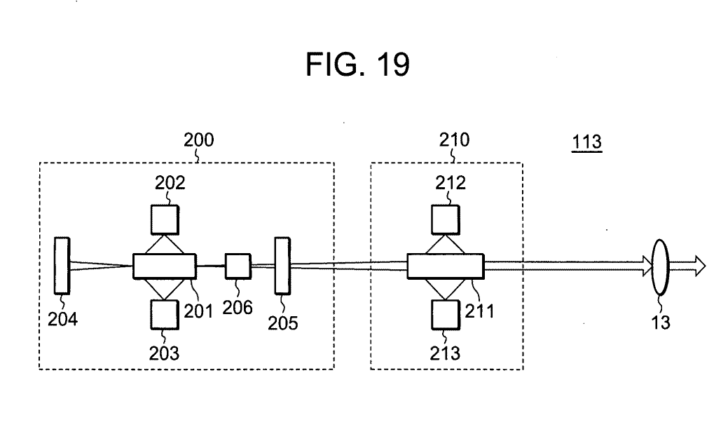

FIG. 19 is a view showing a configuration of a third modification of a laser source device according to the embodiment. With reference to FIG. 19, the laser source device 113 includes a solid-state amplifier as an optical amplifier. With reference to FIGS. 19 and 18, the structural difference between the laser source device 113 and the laser source device 112 is described. The laser source device 113 is different from the laser source device 112 in that it has a solid-state amplifier 210 in place of the optical fibers 1A and 8, the laser diodes 9A to 9D, the coupler 10, the isolator 11 and the end cap 12.

The solid-state amplifier 210 includes a laser medium 211, exciting beam sources 212 and 213. The laser medium 211 is a solid medium, for example Nd-YAG crystal. The exciting beam sources 212 and 213 emit an exciting beam to excite the laser medium 211.

The exciting beam sources 212 and 213 decreases the power of the exciting beam during the supplemental irradiation period, while they increase the power of the exciting beam during the principal irradiation period. Further, the exciting beam sources 212 and 213 increase the power of the exciting beam before the laser diode resonator 200 changes the seed beam from the substantially continuous beam to the pulse beam. For example, the exciting beam sources 212 and 213 are controlled by the control part 20 (see FIG. 1) to change the power of the exciting beam. The control part 20 lowers the power of the exciting beam when the seed beam changes from the pulse beam to the substantially continuous beam, while it increases the power of the exciting beam before the seed beam changes from the substantially continuous beam to the pulse beam by controlling the Q-switch 206 and the exciting beam sources 212 and 213.

The laser media 201 and 211 are not limited to solid media. They may be gas (for example CO₂) or fluid media.

Further, a laser resonator capable of continuously oscillating may be adopted as the seed beam source. In this case, a means capable of passing or blocking a beam (such as a shutter) can be used as an emission control part.

In the configuration shown in FIG. 19, the laser diode resonator 200 as the seed beam source may be replaced by the seed beam source as shown in FIG. 1 (the laser diode 2 for switching to emit a pulse beam or a substantially continuous beam) or the seed beam source as shown in FIG. 17 (the laser diode 2 for emitting a pulse beam and the laser diode 2A for emitting a substantially continuous beam).

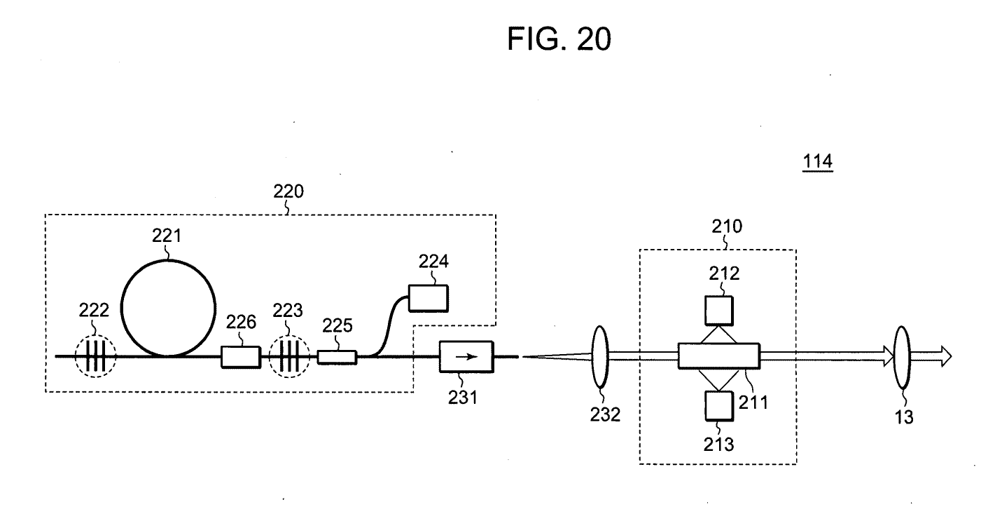

FIG. 20 is a view showing a configuration of a fourth modification of a laser source device according to the embodiment. With reference to FIG. 20, the laser source device 114 includes a fiber resonator 220 as the seed beam source. With reference to FIGS. 20 and 19, the structural difference between the laser source device 114 and the laser source device 113 is described. The laser source device 114 is different from the laser source device 113 in that it has a fiber resonator 220, an isolator 231 and a collimator lens 232 in place of the solid-state laser resonator 200.

The fiber resonator 220 includes an optical fiber 221, fiber-bragg gratings 222 and 223, an exciting beam source 224, a coupler 225 and Q-switch 226.

The optical fiber 221 is the same optical fiber having a rare-earth doped core as the optical fibers 1 and 8. The fiber-bragg gratings 222 and 223 are diffracting gratings formed in an optical fiber, which has the same functions as the reflection mirror 204 and the emitting mirror 205 respectively (see FIG. 18). The exciting beam source 224 emits an exciting beam for exciting the rare-earth element included in the core of the optical fiber 221. The exciting beam is entered into the optical fiber 221 through the coupler 225. A seed beam is emitted from the fiber resonator 220 by turning the Q-switch 226 on and off. In the same manner as the solid-state laser resonator 200, it is possible to emit the substantially continuous beam as the seed beam from the fiber resonator 220 by turning the Q-switch on and off such that the non-emission period of the seed beam is shorter than the emission period of the pulse beam.

In the configuration shown in FIG. 20, the solid-state amplifier 210 may be replaced by a fiber amplifier (for example the optical fiber 1 as shown in FIG. 1) and an exciting beam source (for example the laser diodes 9A to 9D as shown in FIG. 1).

The seed beam source is not limited to a laser diode, but a laser beam source such as a solid-state laser resonator and a fiber resonator may be adopted as described above. Further, the optical amplifier is not limited to a fiber amplifier, but a solid-state amplifier may be adopted as well. A combination of a seed beam source and an optical amplifier is also not limited to what is described above. Although it is not shown in drawings, for example a laser source device having a fiber resonator and a fiber amplifier can be also included in the laser source device according to the embodiment.

A laser marking device is shown as one aspect of a laser processing device including a laser source device according to the embodiment. However, the processing using a laser beam is not limited to marking. In other words, the laser processing device including the laser source device according to the invention is not limited to a laser marking device. For example, a laser beam can be used for drilling, welding, cutting, thermal treatment, shape processing and trimming, etc. Thus, the laser processing device according to the invention is applicable to use as those laser processing devices. For example, a laser trimming device and a laser repair device for repairing a photomask, etc. can be included as the laser processing device according to the invention.

Further, the laser source device is applicable to a laser processing device according to one aspect of the embodiment. However the laser source device according to the invention is not limited to use as a laser processing device. For example, the laser source device according to the invention may be applied to a medical device.

The embodiments as described above are all examples which should not be taken to limit the scope of the invention. The scope of the invention is to be defined not by the above description but by claims and is intended to include all equivalents and modifications without departing from the scope of the invention.

1. A laser source device, comprising:
an optical amplifier including an optical amplifying medium configured to amplify a seed beam when the seed beam and an exciting beam are applied thereto,
a seed beam source configured to emit a laser beam as the seed beam, and
an exciting beam source configured to emit the exciting beam, wherein
during a predetermined principal irradiation period, the seed beam source emits a pulse beam as the seed beam
during a supplemental irradiation period different from the principal irradiation period, the seed beam source emits a substantially continuous beam having less power than a peak power of the pulse beam as the seed beam, and
the exciting beam source emits the exciting beam at a lower power during the supplemental irradiation period than during the principal irradiation period.

2. The laser source device according to claim 1, wherein
the exciting beam source boosts a power of the exciting beam before the seed beam changes from the continuous beam to the pulse beam.

3. The laser source device according to claim 1, wherein
the optical amplifier is an optical fiber amplifier and the optical amplifying medium is an optical fiber having a rare-earth doped core.

4. The laser source device according to claim 1, wherein
the optical amplifier includes a solid laser medium as the optical amplifying medium.

5. The laser source device according to claim 1, wherein
the seed beam source includes a first beam source for emitting the pulse beam and a second beam source for emitting the continuous beam.

6. The laser source device according to claim 5, wherein
the wavelength of the pulse beam is different from the continuous beam, and
the laser source device further includes a separating device configured to separate the pulse beam and the continuous beam based on the respective wavelength of the pulse beam and the continuous beam.

7. The laser source device according to claim 1, wherein
the seed beam source includes at least one laser diode.

8. The laser source device according to claim 1, wherein
the seed beam source includes an emission control part configured to enable cyclically emitting the seed beam, and
the emission control part emits the continuous beam as the seed beam by making a non-emission period of the seed beam shorter than an emission period of the pulse beam.

9. The laser source device according to claim 8, wherein
the emission control part includes a Q-switch.

10. The laser source device according to claim 9, wherein
the seed beam source further includes a solid-state laser resonator.

11. The laser source device according to claim 9, wherein
the seed beam source further includes an optical fiber resonator.

12. A laser processing device, comprising:
a laser source device according to claim 1, and
an optical system for irradiating an object with a beam emitted from the laser source device.

13. The laser processing device according to claim 12, wherein
the laser processing device is a laser marking device.

14. The laser processing device according to claim 12, wherein
the laser processing device is a laser trimming device.

15. The laser processing device according to claim 12, wherein
the laser processing device is a laser repair device.
